(19) United States
(12) Patent Application Publication
(10) Pub. No.: US 2026/0124932 A1
(43) Pub. Date: May 7, 2026

(54) ELECTRIFIED VEHICLE AND A METHOD OF CONTROLLING THE SAME

(71) Applicants: HYUNDAI MOTOR COMPANY, Seoul (KR); KIA CORPORATION, Seoul (KR)

(72) Inventors: Jin Kyeom Cho, Hwaseong-si (KR); Dong Hyeon Woo, Hwaseong-si (KR)

(73) Assignees: HYUNDAI MOTOR COMPANY, Seoul (KR); KIA CORPORATION, Seoul (KR)

(21) Appl. No.: 19/227,980

(22) Filed: Jun. 4, 2025

(30) Foreign Application Priority Data
Nov. 1, 2024 (KR) 10-2024-0153410

(51) Int. Cl. B60L 50/61; B60L 7/10

(52) U.S. Cl. CPC B60L 50/61; B60L 7/10; B60L 2240/547; B60L 2240/62; B60L 2250/30; B60L 2270/142

(57) ABSTRACT

An electrified vehicle includes: a motor; a battery connected to the motor, the battery configured to drive the motor by discharging, and the battery configured to be charged through a driving force of the motor; and a controller configured to manage a state of charge (SOC) of the battery based on a predicted execution count of audio control. The audio control includes one or more of an audio guidance output or a voice command input.

### CROSS REFERENCE TO RELATED APPLICATION

The present application claims the benefit of and priority to Korean Patent Application No. 10-2024-0153410 filed on Nov. 1, 2024, the entire contents of which are incorporated herein by reference.

### TECHNICAL FIELD

The present disclosure relates to an electrified vehicle and a method of controlling the same. The electrified vehicle and the method manage a state of charge (SOC) of a battery for smooth operation of an audio control function.

### BACKGROUND

In recent years, audio control functions have been actively applied to vehicles. The audio control functions include the function of outputting audio guidance and inputting voice commands that involves inputting a destination into a navigation system through a driver's voice. The audio control functions include the function of outputting turn-by-turn guidance through voice when giving directions.

In the audio control functions, ambient noise may affect the operation performance due to the nature of the audio control functions, which involves outputting audio and receiving voice commands. For example, if ambient noise interferes while audio guidance is being output, a vehicle user such as a driver may have difficulty recognizing the content of the audio guidance. If ambient noise interferes while the vehicle user is inputting a voice command, the ambient noise may act as an unwanted sound in the command and may prevent the accurate input of the command. Therefore, functions to control ambient noise in various ways may be applied for smooth operation of the audio control functions.

For example, in an electrified vehicle such as a hybrid vehicle or an electric vehicle, the execution of the audio control functions may involve control to reduce ambient noise by adjusting an operating point of a power source or a driving mode depending on the power source.

However, as a state of charge (SOC) of a battery may act as a constraint on such control to reduce ambient noise, it is necessary to ensure that the SOC of the battery is sufficiently secured prior to an audio control execution so as to enable a smooth execution of ambient noise reduction control during the execution of the audio control function.

The matters described above as a background art are provided solely to facilitate a better understanding of the background of the present disclosure and should not be construed as an admission that they constitute a related art already known to those having ordinary skill in the art.

### SUMMARY OF THE DISCLOSURE

An objective of the present disclosure is to provide an electrified vehicle and a method of controlling the same. The electrified vehicle and the method may secure in advance a state of charge (SOC) of a battery before executing noise reduction control for audio control.

Technical objectives of the present disclosure are not limited to the technical objectives mentioned above, and other technical objectives not mentioned above should be clearly understood by those having ordinary skill in the art from the following description.

According to an embodiment of the present disclosure, an electrified vehicle includes a motor. The electrified vehicle also includes a battery connected to the motor, the battery is configured to supply power to the motor by discharging, and the battery is configured to be charged using a driving force of the motor. The electrified vehicle also includes a controller configured to manage a state of charge (SOC) of the battery based on a predicted execution count of audio control. The audio control includes one or more of an audio guidance output or a voice command input.

An embodiment of the present disclosure provides a method of controlling an electrified vehicle including a motor and a battery connected to the motor. The battery is configured to drive the motor by discharging, and the battery is configured to be charged using a driving force of the motor. The method includes managing a state of charge (SOC) of the battery, based on a predicted execution count of audio control. The audio control includes one or more of audio guidance output or voice command input.

According to embodiments of the present disclosure as described above, by securing in advance the SOC of the battery before executing noise reduction control for audio control, it becomes possible to prevent a situation in which noise reduction control may not be smoothly executed due to insufficient SOC of the battery.

In addition, because noise reduction control during audio control may operate smoothly through the secured SOC of the battery in advance, noise generated in a vehicle is reduced. Thus, the recognition rate of a voice command in the vehicle is enhanced, and it is easier for a driver to recognize voice guidance output from the vehicle.

The effects which may be achieved in the present disclosure are not limited to the effects mentioned above, and other effects not mentioned above should be clearly appreciated from the following description by those having ordinary skill in the art.

### BRIEF DESCRIPTION OF THE DRAWINGS

FIG. 1 is a view showing a configuration of an electrified vehicle according to an embodiment of the present disclosure.

FIG. 2 is a view showing an implementation example of the electrified vehicle according to an embodiment of the present disclosure.

FIG. 3 is a view showing a configuration of a controller according to an embodiment of the present disclosure.

FIGS. 4 and 5 are views illustrating state of charge (SOC) management of a battery according to an embodiment of the present disclosure.

FIG. 6 is a flowchart illustrating a control process of the electrified vehicle according to an embodiment of the present disclosure.

### DETAILED DESCRIPTION OF THE DISCLOSURE

Specific structural and functional descriptions of embodiments of the present disclosure disclosed herein have been illustrated merely for the purpose of describing embodiments according to the present disclosure. Embodiments according to the present disclosure may be implemented in various forms and thus should not be construed as being limited to embodiments described herein.

Embodiments according to the present disclosure are subject to various modifications and may have many forms, and thus certain embodiments are illustrated by way of example in the accompanying drawings and described in detail in the present disclosure. However, it should be understood that it is not intended to limit the embodiments of the present disclosure to specific forms of embodiments. Instead, the embodiments include all modifications, equivalents, and substitutes included in the spirit and scope of the present disclosure.

Unless otherwise defined, all terms used herein, including technical or scientific terms, shall have the same meaning as commonly understood by those having ordinary skill in the art. It should be further understood that terms, such as those defined in commonly used dictionaries, should be interpreted as having a meaning consistent with their meanings in the context of the relevant art. The terms shall not be construed to have an idealized or unduly formal meaning unless expressly so defined herein.

Hereinafter, embodiments disclosed herein are described in detail with reference to the drawings. The same reference numerals are given to the same or similar components, and a repetitive description thereof has been omitted.

In the description of the following embodiments, when a parameter is referred to as being “preset,” it may be intended to mean that a value of the parameter is predetermined when the parameter is used in a process or an algorithm. The value of the parameter may be set at the start of the process or the algorithm or may be set during the execution of the process or the algorithm, depending on the embodiments.

As used in the following description, the terms “module” and “part” for a component are used or interchangeably used solely for ease of preparation of the specification and do not have different meanings. When a controller, module, component, device, element, part, or the like of the present disclosure is described as having a purpose or performing an operation, function, or the like, the controller, module, component, device, element, part, or the like should be considered herein as being “configured to” meet that purpose or to perform that operation or function. Each controller, module, component, device, element, part, and the like may separately embody or be included with a processor and a memory, such as a non-transitory computer readable media, as part of the apparatus.

In describing embodiments disclosed herein, when a detailed description of a known related art is determined to obscure the gist of the present disclosure, the detailed description thereof has been omitted herein. In addition, the accompanying drawings are merely for easy understanding of the embodiments disclosed herein, and the technical spirit disclosed herein is not limited by the accompanying drawings. It should be understood to include all modifications, equivalents, and substitutes included in the spirit and scope of the present disclosure.

Terms including ordinal numbers such as first, second, and the like used herein may be used to describe various components. However, the various components are not limited by these terms. The terms are used only for the purpose of distinguishing one component from another component.

When a component is referred to as being “connected” or “coupled” to another component, the component may be directly connected or coupled to another component. However, it should be understood that still another component may be present between the component and another component. Conversely, when a component is referred to as being “directly connected” or “directly coupled” to another, it should be understood that still another component may not be present between the component and another component.

Unless the context clearly dictates otherwise, the singular form includes the plural form.

The terms “comprising,” “having,” or the like as used herein are used to specify that a feature, a number, a step, an operation, a component, an element, or a combination thereof described herein exists. The terms do not preclude the possibility of the presence or addition of one or more other features, numbers, steps, operations, components, elements, or combinations thereof.

In addition, a unit or a control unit included in the terms such as a motor control unit (MCU) and a hybrid control unit (HCU) is only a term widely used as a controller that controls the specific function of a vehicle. The term does not mean a generic function unit.

A controller may include a communication device for communicating with other control units or sensors to control a responsible function. The controller may include a memory for storing an operating system, a logic command, and input/output information. The controller may include one or more processors for executing determination, calculation, and decision, which are necessary for controlling the responsible function.

An embodiment of the present disclosure proposes to manage a state of charge (SOC) of a battery based on a predicted execution count of audio control and thus ensure smooth operation of noise reduction control executed for audio control.

Here, the noise reduction control may be executed, for example, by changing an operating point of a power source including an engine and a motor, by changing a driving mode based on the power source, and the like. The noise reduction control may be selectively executed based on an interior noise level when an audio control function is executed or expected to be executed.

For example, noise reduction control through changing an operating point of a power source may be executed by utilizing a noise map defined by torque and revolutions per minute (RPM) for the engine and motor and changing the operating point to an operating point that generates lower noise. Furthermore, the noise reduction control through changing a driving mode based on the power source may be executed by adjusting the criteria for driving mode switching to trigger an engine-off state.

However, noise reduction control for audio control according to an embodiment is not necessarily limited to the above examples. Any noise reduction control that is aimed at reducing vehicle interior noise for the purpose of executing audio control, and that requires consumption of power stored in the battery to execute the audio control may be included in the noise reduction control described above.

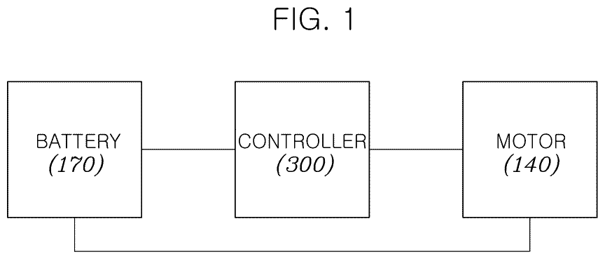

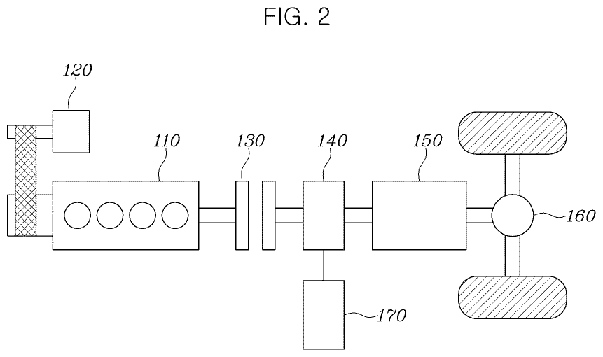

Before describing a specific control method of an electrified vehicle according to an embodiment of the present disclosure, an example of a configuration and implementation of an electrified vehicle is described below with reference to FIGS. 1 and 2.

FIG. 1 is a view showing a configuration of an electrified vehicle according to an embodiment of the present disclosure. FIG. 2 is a view showing an implementation example of the electrified vehicle according to an embodiment of the present disclosure.

First, referring to FIG. 1, an electrified vehicle according to an embodiment includes a battery 170, a motor 140, and a controller 300. However, FIG. 1 shows components related to the description of an embodiment, and an actual electrified vehicle may be implemented with more components beyond those shown components.

The motor 140 and the battery 170 are interconnected. The motor 140 may be driven by the discharge of the battery 170 to provide power to the electrified vehicle and may charge the battery 170 through the driving force.

The controller 300 may predict an execution of audio control and may manage the SOC of the battery 170 based on a predicted execution count of audio control (e.g., based on a prediction being made about how many times the audio control will be executed). Here, the SOC of the battery 170 indicates how much the battery 170 is charged and may be expressed as a percentage (%) of a charge amount relative to a total charge capacity of the battery 170.

To manage the SOC of the battery 170, the controller 300 may limit the power consumed by the motor 140 or may charge the battery 170 through the motor 140. To this end, a more specific structure of the electrified vehicle is described with reference to FIG. 2.

Referring to FIG. 2, the electrified vehicle according to an embodiment may include an engine 110, a starter generator 120, an engine clutch 130, a transmission 150, a final reduction gear 160, and the like, in addition to the motor 140 and the battery 170. To be more specific, FIG. 2 illustrates a power train structure of a hybrid vehicle employing a parallel type hybrid system in which the motor 140 and the engine clutch 130 are mounted between the engine 110 and the transmission 150.

In such an electrified vehicle, in general, when a driver presses an accelerator (i.e., when an accelerator pedal sensor is on) after starting the engine, with the engine clutch 130 open, the motor 140 is first driven by using power from the battery. The power from the motor 140 is then transmitted through the transmission 150 and the final reduction gear 160 to move wheels (i.e., in an electric vehicle (EV) mode). When the vehicle gradually accelerates and requires progressively larger driving force, the starter generator 120 operates to drive the engine 110.

As a result, when a rotational speed difference between the engine 110 and the motor 140 falls within a certain range, the engine clutch 130 engages, and thus the engine 110 and the motor 140 are enabled to jointly drive the vehicle (i.e., transition from the EV mode to a hybrid electric vehicle (HEV) mode). When preset engine-off conditions, such as the vehicle decelerating, are met, the engine clutch 130 opens and the engine 110 stops (i.e., transition from HEV mode to EV mode). At this point, the vehicle uses the driving force of the wheels to charge the battery 170 through the motor 140. This is a process known as braking energy recovery or regenerative braking.

Through such a configuration, the controller 300 may manage the SOC of the battery 170 by controlling the motor 140. However, the electrified vehicle according to an embodiment is not necessarily limited to being implemented in this manner. Instead, the electrified vehicle may be also implemented, for example, as an electric vehicle that only has the motor 140 as a power source, without being provided with the engine 110.

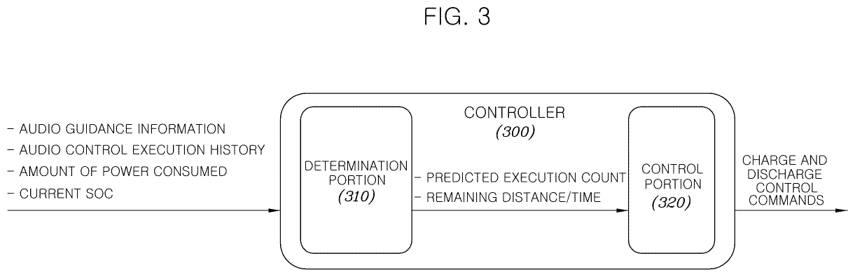

A specific method of controlling the electrified vehicle according to an embodiment is described below with reference to FIG. 3.

FIG. 3 is a view showing a configuration of a controller according to an embodiment of the present disclosure.

Referring to FIG. 3, the controller 300 may include a determination portion 310 and a control portion 320. The controller 300 may have input information such as important voice guidance information, history of audio control execution, an amount of power consumed during an audio control execution, and a current SOC. The controller 300 may output information such as a control command to control the charging and discharging of the battery 170.

The determination portion 310 may predict an audio control execution. The audio control may include the output of audio guidance and the input of a voice command. More specifically, the audio guidance may include, but is not necessarily limited to, information in the form of voice, such as a navigation guidance voice. For example, the audio guidance may include all types of audio guidance output through a speaker, such as a non-voice warning tone. In addition, a voice command refers to a control command input by a user of the electrified vehicle, such as a driver, through voice. The voice command may be implemented in such a way that, for example, when the driver inputs a voice command “Show me the route home,” a vehicle system such as a navigation system provides a corresponding route.

Predicting the execution of audio control may refer to predicting whether audio control will be executed in the future. Predicting the execution of audio control may include predicting i) when or where the audio control will be executed, ii) the number of times the audio control will be executed (i.e., a predicted execution count of the audio control), and iii) the type of audio control to be executed.

More specifically, the determination portion 310 may predict the execution of audio control based on history of the audio control execution. For example, if there is history of multiple instances of audio control executions at a particular location or particular time in the past, the determination portion 310 may predict that audio control will be executed at the particular location or time.

In addition, the determination portion 310 may predict the execution of audio guidance and the execution of a voice command separately and may further predict the audio guidance and the voice command separately for each type thereof. In addition, audio guidance here may mean all types of audio guidance executed in the vehicle but may also include only important audio guidance. In this case, important audio guidance may be preset based on the content output through audio included in the audio guidance information. Instead of predicting and considering all types of audio guidance to manage the SOC of the battery 170, only some important audio guidance may be predicted and considered, and thus inconvenience caused by excessive control intervention may be prevented.

As such, when an execution of the audio control is predicted, the determination portion 310 transmits, to the control portion 320, the result of the prediction, which may include a predicted execution count of the audio control and a remaining distance and remaining time until the audio control is executed.

The control portion 320 may manage the SOC of the battery 170 based on the predicted execution count of the audio control and may output charge and discharge control commands to this end. In this case, the charge and discharge commands may include a control command for the motor 140, through which power consumption, charging, etc. of the battery 170 through the motor 140 may be controlled. In addition, if the electrified vehicle is provided with a separate motor such as the starter generator 120 or with the engine 110, the SOC of the battery 170 may be managed through charge and discharge control commands therefor.

More specifically, the control portion 320 may manage the SOC of the battery 170 based on the predicted execution count of audio control such that the SOC of the battery 170 has a higher value. For example, when the predicted execution count is a second count (e.g., a second predetermined value) exceeding a first count (e.g., a first predetermined value), compared to when the predicted execution count is the first count, the control portion 320 may manage the SOC of the battery 170 such that the SOC of the battery 170 has a higher value. In this case, a point in time for comparing the SOC values between when the predicted execution count is the first count and when the predicted execution count is the second count may be based on a point in time when audio control is executed.

To this end, the control portion 320 may charge the battery 170 with an amount of charging power that has a positive correlation with the predicted execution count up to the point in time when audio control is executed. In this case, the predicted execution count and the amount of charging power may be directly proportional, but are not necessarily limited thereto, and a case where the ratio between the amount of charging power and the predicted execution count is not constant may also be included.

In this case, the amount of charging power may correspond to the sum of the amount of power consumed during each of a plurality of audio control executions, and the amount of power consumed during the execution of audio control may include the amount of power consumed for noise reduction during the execution of audio control.

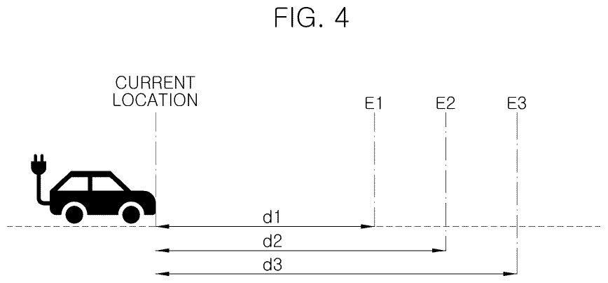

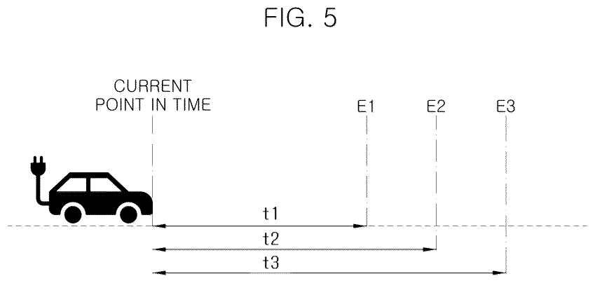

In addition, the control portion 320 may control charging power for charging the battery 170 with the amount of charging power, as described below with reference to FIGS. 4 and 5.

FIGS. 4 and 5 are views illustrating SOC management of a battery according to an embodiment of the present disclosure.

First, referring to FIG. 4, the control portion 320 may control the charging power of the battery 170 to charge the battery 170 with the amount of charging power, based on a remaining distance until audio control is executed.

In this case, the charging power of the battery 170 may have a negative correlation with the time required to travel the remaining distance, and the control portion 320 may execute control using a value obtained by dividing the amount of charging power by the time required to travel the remaining distance. Accordingly, at a point where the predicted audio control is executed, the battery 170 may have sufficient SOC for executing noise reduction control for audio control.

For example, if a first audio control event E1 is predicted to be executed at a location d1 away from a current location, the control portion 320 may charge the battery 170 with charging power corresponding to a value obtained by dividing the amount of power consumed during execution of the first audio control event E1 while the electrified vehicle is traveling the distance d1 by the time required to travel the distance d1.

In addition, when a plurality of audio control executions are predicted, the control portion 320 may control the charging power, based on the amount of charging power corresponding to the sum of the amount of power consumed for noise reduction control during each of the plurality of predicted audio control executions and the remaining distance until the audio control that is executed last among the predicted audio control executions is executed. In this case, the amount of power consumed during noise reduction control for audio control may be a preset value or may be applied as a constant value, but may vary depending on the situation during each control execution.

For example, if the executions of the first audio control event E1, a second audio control event E2, and a third audio control event E3 are predicted at locations d1, d2, and d3 away from the current location, respectively, the amount of charging power is decided by summing the amount of power consumed to execute noise reduction control for the executions of the first audio control event E1, the second audio control event E2, and the third audio control event E3, respectively. The charging power of the battery 170 may be a value obtained by dividing the amount of charging power by the time required to travel the remaining distance d3 of the third audio control event E3 having the largest remaining distance.

In addition, referring to FIG. 5, the control portion 320 may control the charging power of the battery 170, based on the remaining time until the predicted audio control is executed, along with the amount of charging power.

In this case, the charging power of the battery 170 may have a negative correlation with the remaining time, and the control portion 320 may control the charging power using a value obtained by dividing the amount of charging power by the remaining time. Accordingly, at a point in time when the predicted audio control is executed, the battery 170 may have sufficient SOC to execute noise reduction control for audio control. For example, if the first audio control event E1 is predicted to be executed at a point in time t1 after a current point in time, the control portion 320 may charge the battery 170 with charging power corresponding to a value obtained by dividing the amount of power consumed for time t1 during the first audio control event E1 by the remaining time t1.

In addition, when a plurality of audio control executions are predicted, the control portion 320 may control the charging power, based on the amount of charging power corresponding to the sum of the amount of power consumed for noise reduction control during each of the plurality of predicted audio control executions and the remaining time until the audio control that is executed last among the predicted audio control executions is executed. In this case, the amount of power consumed during noise reduction control for audio control may be a preset value or may be applied as a constant value. Alternatively, the amount of power consumed during noise reduction control for audio control may vary based on the situation during an audio control execution.

For example, if the executions of the first audio control event E1, the second audio control event E2, and the third audio control event E3 are predicted at points in time t1, t2, and t3 after a current point in time, respectively, the amount of charging power is decided by summing the amount of power consumed to execute noise reduction control for the executions of the first audio control event E1, the second audio control event E2, and the third audio control event E3, respectively. The charging power of the battery 170 may be a value obtained by dividing the amount of charging power by the remaining time t3 of the third audio control event E3 having the largest remaining time.

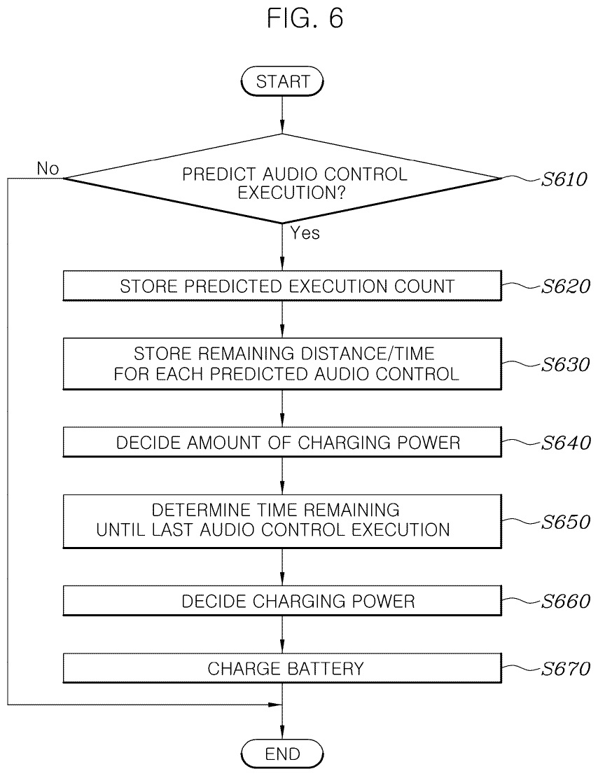

A control process of the electrified vehicle described so far is described below with reference to FIG. 6.

FIG. 6 is a flowchart illustrating a control process of the electrified vehicle according to an embodiment of the present disclosure.

Referring to FIG. 6, the controller 300 may predict an execution of audio control (S610). When the execution of audio control is predicted (Yes in S610), the controller 300 may store a predicted execution count of audio control and a remaining distance or remaining time for each predicted audio control (S620 and S630).

Based on the predicted execution count, the controller 300 may determine an amount of power consumed for noise reduction control for the predicted audio control (S640) and may decide an amount of charging power based on the determined amount of power (S640).

In addition, the controller 300 may determine time remaining until the last audio control execution among the plurality of predicted audio control executions (S650) and may decide the charging power of the battery 170 by dividing the amount of charging power by the determined time (S660).

Subsequently, the battery 170 is charged with charging power until the last audio control execution among the predicted audio control executions is executed (S670). Thus, sufficient SOC to execute noise reduction control during audio control may be secured.

According to various embodiments of the present disclosure as described above, by securing in advance the SOC of the battery before executing noise reduction control for audio control, it becomes possible to prevent a situation in which noise reduction control may not be smoothly executed due to insufficient SOC of the battery.

In addition, because noise reduction control during audio control may operate smoothly through the secured SOC of the battery in advance, noise generated in the vehicle is reduced. Thus, the recognition rate of a voice command in the vehicle may be enhanced, and it is easier for the driver to recognize voice guidance output from the vehicle.

Although the specific embodiments of the present disclosure have been illustrated and described as described above, those having ordinary skill in the art should appreciate that various modifications and changes to the present disclosure may be made without departing from the technical spirit of the present disclosure provided in the following claims.

What is claimed is:

1. An electrified vehicle including:
a motor;
a battery connected to the motor, the battery configured to supply power to the motor by discharging and to be charged using a driving force of the motor; and
a controller configured to manage a state of charge (SOC) of the battery based on a predicted execution count of an audio control, the audio control including one or more of an audio guidance output or a voice command input.

2. The electrified vehicle of claim 1, wherein when the predicted execution count is equal to a second predetermined value exceeding a first predetermined value, the controller is configured to manage the SOC of the battery to be higher than an SOC of the battery when the predicted execution count is equal to the first predetermined value.

3. The electrified vehicle of claim 2, wherein the controller is configured to manage the SOC of the battery by charging the battery with an amount of charging power that has a positive correlation with the predicted execution count until the audio control is executed.

4. The electrified vehicle of claim 3, wherein when a plurality of audio control executions is predicted, the amount of charging power corresponds to a sum of the amount of power consumed during each of the plurality of predicted audio control executions.

5. The electrified vehicle of claim 3, wherein the amount of charging power corresponds to an amount of power consumed for noise reduction control involved during an audio control execution.

6. The electrified vehicle of claim 3, wherein the controller charges the battery with charging power that has a negative correlation with a remaining distance or remaining time until the audio control is executed.

7. The electrified vehicle of claim 6, wherein when a plurality of audio control executions is predicted, the controller charges the battery with charging power that has a negative correlation with the remaining distance or remaining time of a last audio control execution among the plurality of predicted audio control executions.

8. The electrified vehicle of claim 1, wherein the audio guidance output is preset based on content output through audio.

9. The electrified vehicle of claim 1, wherein the controller is configured to predict an execution of the audio control based on history of a plurality of audio control executions.

10. A method of controlling an electrified vehicle including a motor and a battery connected to the motor, the battery configured to drive the motor by discharging, and the battery configured to be charged through a driving force of the motor, the method including:
managing a state of charge (SOC) of the battery, based on a predicted execution count of audio control, the audio control including one or more of an audio guidance output or a voice command input.

11. The method of claim 10, wherein managing the SOC of the battery comprises controlling, when the predicted execution count is equal to a second predetermined value exceeding a first predetermined value, the SOC of the battery to be higher than an SOC of the battery when the predicted execution count is the first predetermined value.

12. The method of claim 11, wherein managing the SOC of the battery includes charging the battery with an amount of charging power that has a positive correlation with the predicted execution count until the audio control is executed.

13. The method of claim 12, wherein when a plurality of audio control executions is predicted, the amount of charging power corresponds to a sum of the amount of power consumed during each of the plurality of predicted audio control executions.

14. The method of claim 12, wherein the amount of charging power corresponds to an amount of power consumed for noise reduction control involved during an audio control execution.

15. The method of claim 12, wherein charging includes charging the battery with charging power that has a negative correlation with a remaining distance or remaining time until the audio control is executed.

16. The method of claim 15, wherein when a plurality of audio control executions is predicted, charging includes charging the battery with charging power that has a negative correlation with the remaining distance or remaining time of a last audio control execution among the plurality of predicted audio control executions.

17. The method of claim 10, wherein the audio guidance output is preset based on content output through audio.

18. The method of claim 10, further including predicting an execution of the audio control based on history of a plurality of audio control executions.

19. The method of claim 10, wherein managing the SOC of the battery comprises:
controlling discharging and charging of the battery through a motor; or
controlling the discharging and the charging of the battery through a starter generator or an engine.

20. The method of claim 19, wherein controlling the charging of the battery comprises:
controlling the charging of the battery with charging power corresponding to a value obtained by dividing an amount of charging power required during an execution of the audio control, while the electrified vehicle is traveling a remaining distance, by time required electrified for the vehicle to travel the remaining distance.
